(19) United States
(12) Patent Application Publication
(10) Pub. No.: US 2004/0205620 A1
(43) Pub. Date: Oct. 14, 2004

(54) Information distributing program, computer-readable recording medium recorded with information distributing program, information distributing apparatus and information distributing method

(75) Inventors: Masaaki Nishikiori, Kawasaki (JP); Yuji Takada, Kawasaki (JP); Kohtaro Egawa, Kawasaki (JP); Hiroshi Murano, Kawasaki (JP); Hideo Shimizu, Kawasaki (JP); Hidemitsu Manaka, Kawasaki (JP); Masashi Ogawa, Kawasaki (JP); Shino Miyashita, Kawasaki (JP); Koichi Yamashita, Kahoku-gun (JP); Kazunori Mizushima, Kahoku-gun (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/118,977

(22) Filed: Apr. 10, 2002

(30) Foreign Application Priority Data
Dec. 13, 2001 (JP) 2001-380588

(51) Int. Cl. G06F 17/24; G06F 17/21; G06F 17/00

(52) U.S. Cl. 715/523; 715/513; 715/501.1

(57) ABSTRACT

An information distributing program, a computer-readable recording medium recorded with the information distributing program, an information distributing apparatus and an information distributing method, capable of flexibly coping with various connecting terminals without processing the contents accumulated in information sources, by providing a mechanism for dynamically converting the contents created in arbitrary formats according to connecting terminals.

### FIELD OF THE INVENTION

The present invention relates to an information distributing technique for distributing contents accumulated in various information sources, and particularly to a technique for enabling to flexibly cope with various terminals.

### RELATED ART OF THE INVENTION

In recent years, there have been a lot of portal sites for distributing functions required by users, on the core of searching engines and/or link collections, in the Internet. Since portal sites firstly aimed to be utilized by browsers of PCs (personal computers), it was impossible to utilize the portal sites from portable terminals such as cellular phones and PDA's (Personal Digital Assistants), users of which are drastically increased.

Therefore, in order to enable the portal sites to be utilized from not only PC's but also portable terminals, contents for each terminal type are prepared, or contents are created in a convertible common format [such as XML (eXtensible Markup Language)] so that the created contents are converted corresponding to each terminal type.

However, in a case where contents are prepared for each terminal type, it is typical that, on the basis of contents for a certain type of terminal, contents for other types of terminals are created, thereby extremely increasing the cost for creating the whole contents. Contrary, in a case where contents are dynamically converted corresponding to the terminal types, a special technique is required for creating the contents in the convertible common format and a cost required for creating such contents is extremely increased, and also there are imitations on the utilization of existing contents. Further, in both cases, since the contents aimed to be utilized in the WWW (World Wide Web; hereinafter simply called “Web”), it is impossible to utilize EJB (Enterprise JavaBeans) components, DB (Data Base) agents and the like.

### SUMMARY OF THE INVENTION

The present invention has been achieved in view of the conventional problems as described above, and it is therefore an object of the present invention to provide an information distributing technique capable of flexibly coping with various connecting terminals without processing contents accumulated in information sources, by providing a mechanism that dynamically converts the contents created in arbitrary formats according to connecting terminals, respectively.

To this end, in an information distributing technique according to the present invention, when an access request to contents accumulated in information sources is made, a type of connecting terminal is specified based on the access request, the requested contents are obtained in a predetermined format from the information sources, based on the connecting terminal type and a data format of the requested contents, and after the obtained contents in the predetermined format are dynamically converted into a format suitable for the connecting terminal type, the contents are sent to the connecting terminal.

According to such a constitution, the access request to the contents is made from the connecting terminal, the requested contents are obtained in the predetermined format from the information sources, based on the connecting terminal type and the data format of the requested contents. Then, after the contents in the predetermined format are dynamically converted into the format suitable for the connecting terminal type, the contents are sent to the connecting terminal.

Thus, it becomes possible to distribute the contents to users using various terminals, without the necessity of altering the contents accumulated in the information sources. Thus, it becomes possible for content providers to distribute the contents to a lot of users while suppressing an increase in cost required for distributing contents. On the other hand, it becomes possible for the content users to access to the same contents irrespective of the connecting terminal type, for example, to browse the contents from the PC inside a company and from the cellular phone outside the company.

At this time, it is desirable to judge the display capability of the connecting terminal based on the type thereof, and to reshape the contents according to the display capability. Here, the connecting terminal type may be specified, for example, based on the protocol header with respect to the access request. Further, the reshaping of the contents may be performed by referring to templates according to the display capability of the connecting terminal. Moreover, the contents may be divided into multiple contents, according to the display capability of the connecting terminal.

According to such a constitution, by reshaping the contents corresponding to the display capability of the connecting terminal, even when the content's themselves include images or the like in a format and/or a size which are not supported by the connecting terminal, it is possible to display the images by converting them into a format and/or a size supported by the connecting terminal, or to display only the text by deleting the images. Here, the connecting terminal type can be specified based on the protocol header, without modifying the connecting terminal itself. Further, if the contents are reshaped referring to the templates, it becomes possible to flexibly cope with various connecting terminals or with various data formats of contents by the modification or addition of templates. Moreover, by dividing the contents into multiple contents corresponding to the display capability of the connecting terminal, it is possible to assuredly avoid such a defect the contents can not be displayed due to lack of buffer capacity of the connecting terminal.

In addition, the constitution may be such that an identification information storing function for storing identification information of a page, and a page moving function for moving to the page identified by the identification information, are embedded in the contents.

According to such a constitution, it becomes possible to store an arbitrary page, to readily move to the page from another page. Therefore, such as in a cellular phone with a narrow display area, it becomes possible to simplify complicated page moving operations, thereby improving the operability thereof. Further, in a PC with a relatively wide display area, it becomes possible to improve, for example, the efficiency and operability in information searching, by storing a page as a reference.

Further objects and aspects of the present invention will become apparent from the following description of a preferred embodiment when read in conjunction with the accompanying drawings.

### BRIEF EXPLANATION OF THE DRAWINGS

FIG. 1 is a block diagram for distributing information by using a portal server according to the present invention;

FIG. 2 is a detailed block diagram of the portal server;

FIG. 3 is a flowchart showing processing details in the portal server;

FIG. 4 is an explanatory view of data transfer through the portal server;

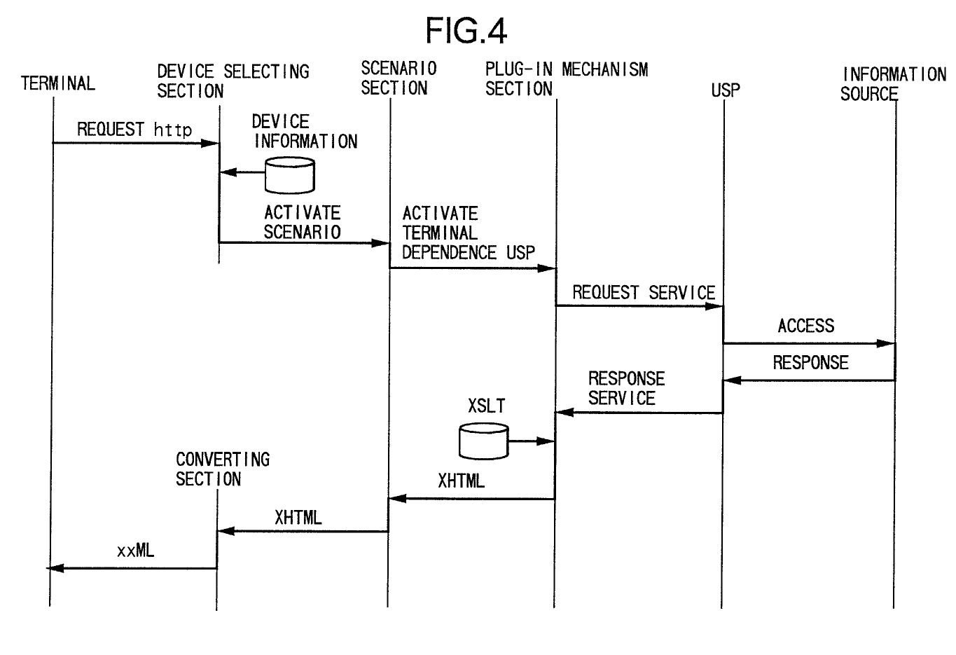

FIG. 5 shows an example of an integrated view to be displayed on a terminal, in which (A) is an explanatory view of an integrated view in a PC and (B) is an explanatory view of an integrated view in a cellular phone;

FIG. 6 is an explanatory view of another example of an integrated view to be displayed on a PC;

FIG. 7 shows another example of an integrated view to be displayed on a terminal, in which (A) is an explanatory view of an integrated view in a PDA and (B) is an explanatory view of an integrated view in a cellular phone; and

FIG. 8 shows a mark-&-jump function, in which (A) is an explanatory view in case of applied to a PC and (B) is an explanatory view in case of applied to a cellular phone.

### PREFERRED EMBODIMENT

There will be described hereinafter the present invention, with reference to the accompanying drawings.

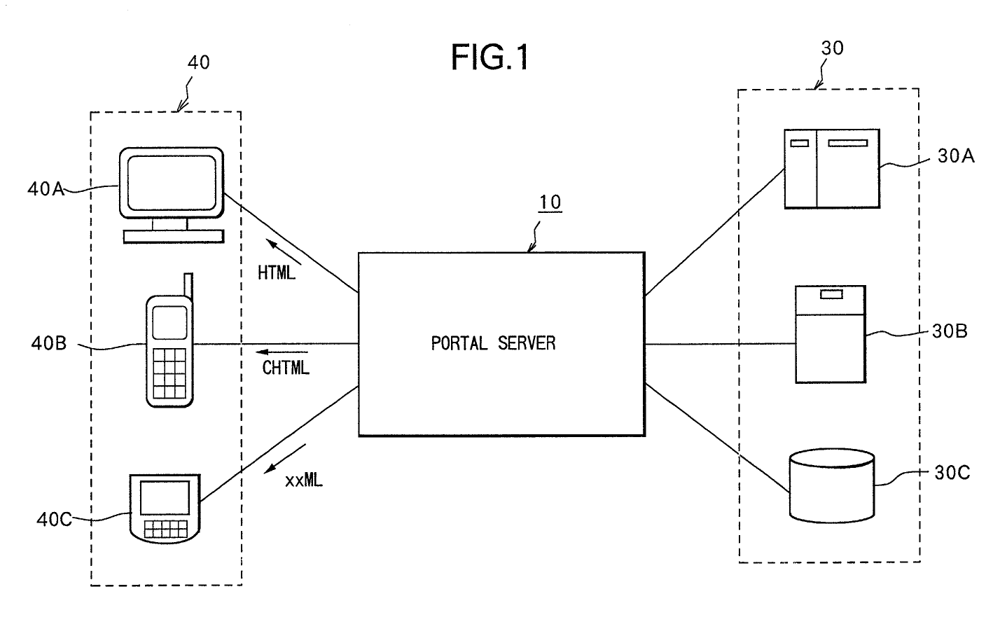

FIG. 1 shows a constitution for distributing information using a portal server applied with the present invention. Note, the portal server is constructed of a computer at least provided with a central processing unit (CPU) and a memory, so as to realize various functions relating to information distribution by means of programs loaded into the memory.

A portal server 10 is connected with an information source 30 including such as, a backbone system 30A, a Web server 30B and a DB 30C, in which various contents are accumulated, via computer networks such as the Internet, and intranet. Here, the contents include Web, EJB components, full-text searching, DB agent, BI (Business Intelligence), WebtoHost, communications, documents, engineering, contents-related management, DB service and the like. The portal server 10 is further connected with a terminal 40 including, such as, a PC 40A using an HTML (HyperText Markup Language) or the like; a cellular phone 40B using a CHTML (Compact HTML) or the like; and a PDA 40C using various ML's (Markup Languages) or the like.

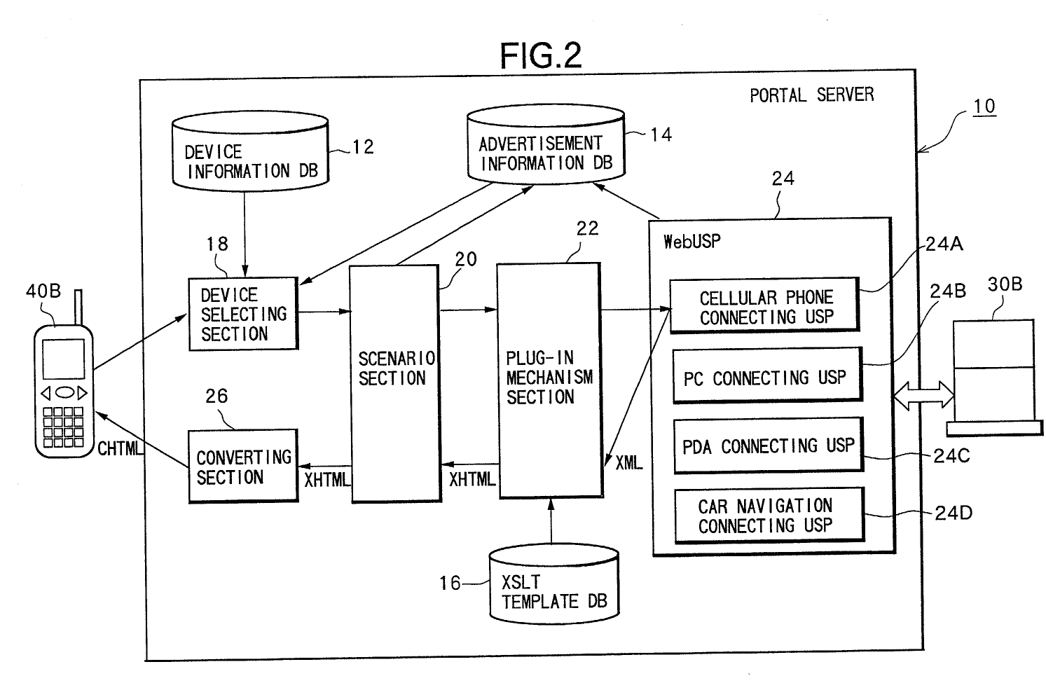

As shown in FIG. 2, the portal server 10 comprises a device information DB 12, an advertisement information DB 14, an XSLT (extensible Stylesheet Language Transform) template DB 16, a device selecting section 18, a scenario section 30, a plug-in mechanism section 22, a USP (Universal Service Plug-in) 24, and a converting section 26.

As device information, the device information DB 12 is registered with resolution, the number of colors, a buffer capacity, availability of image and the like, for each terminal type. The advertisement information DB 14 is registered with information as to which terminal types scenarios (to be detailed later) and the USP 24 will support, and the like. The XSLT template DB 16 is registered with XSLT templates for reshaping the contents into XHTML (extensible HTML) contents for each terminal type, according to a display capability thereof. If an XSLT template is prepared for each contents (i.e., each URL) as required, it becomes possible to precisely cope with fine content reshaping.

In the device selecting section 18, device information indicative of a display capability of a connecting terminal (a terminal connected to the portal server 10, and the same rule is applied in the following) is created, and the scenario and/or USP 24 to be activated are selected. Namely, a header of an http (HyperText Transfer Protocol) request from the terminal 40 is analyzed, and the type of the connecting terminal is specified. Then, the device information DB 12 is referred to, so that the device information corresponding to the connecting terminal is created in a CC/PP (Composite Capability/Preference Profiles) format. Further, the scenario and/or USP 24 are selectively activated (the details thereof will be described later), corresponding to the terminal 40 and information source 30. Note, the device selecting section 18 realizes a type specifying function, a type specifying device, a type specifying step, a display capability judging function, a display capability judging device and a display capability judging step.

In the scenario section 30, the contents fetched via the USP 24 are processed or edited, by users' programs installed as required. Here, the scenario section 30 is provided with a program for each terminal type.

In the plug-in mechanism section 22, the USP 24 for connecting the portal server 10 with the information source 30 is managed. Further, in the plug-in mechanism section 22, an appropriate XSLT template prepared for each of terminal type, USP, URL (Uniform Resource Locator) is applied to the contents fetched via the USP 24, so that the fetched contents are reshaped into XHTML contents according to the display capability of the connecting terminal. Note, the plug-in mechanism section 22 realizes a contents reshaping function, a contents reshaping device and a contents reshaping step.

The USP 24 is an interface module for connecting the portal server 10 with the information source 30, and is prepared for each of information source type and terminal type. Namely, as shown in the figure, the WebUSP for connecting with the Web server 30B comprises, for example, a cellular phone connecting USP 24A, a PC connecting USP 24B, a PDA connecting USP 24C and a car navigation connecting USP 24D. Here, taking account of later addition of various USP's, it is desirable to freely add, modify or delete the USP's so as to enable to flexibly perform the expansion or customization of supporting types. Note, the USP 24 realizes a contents obtaining function, a contents obtaining device and a contents obtaining step.

The converting section 26 comprises a splitter section and a go Mark-up generator section, both not shown in the figure. In the splitter section, the page is divided into displayable sizes, according to the display capability of the connecting terminal. Namely, since portable terminals such as cellular phones are restricted in sizes of displayable contents (including images), it may be impossible to display the page due to lack of buffer capacity. Accordingly, by dividing the page by the splitter section, it is possible to avoid limited accesses due to lack of buffer capacity, without causing users to be conscious to it. Meanwhile, in the Mark-up generator section, an integrated view corresponding to a pertinent connecting terminal type is generated. Note, the Mark-up generator section of the converting section 26 realizes a format converting function, a format converting device and a format converting step. Further, the splitter section of the converting section 26 realizes a contents dividing function, a contents dividing device and a contents dividing step. Moreover, the converting section 26 realizes a contents transmitting function, a contents transmitting device and a contents transmitting step.

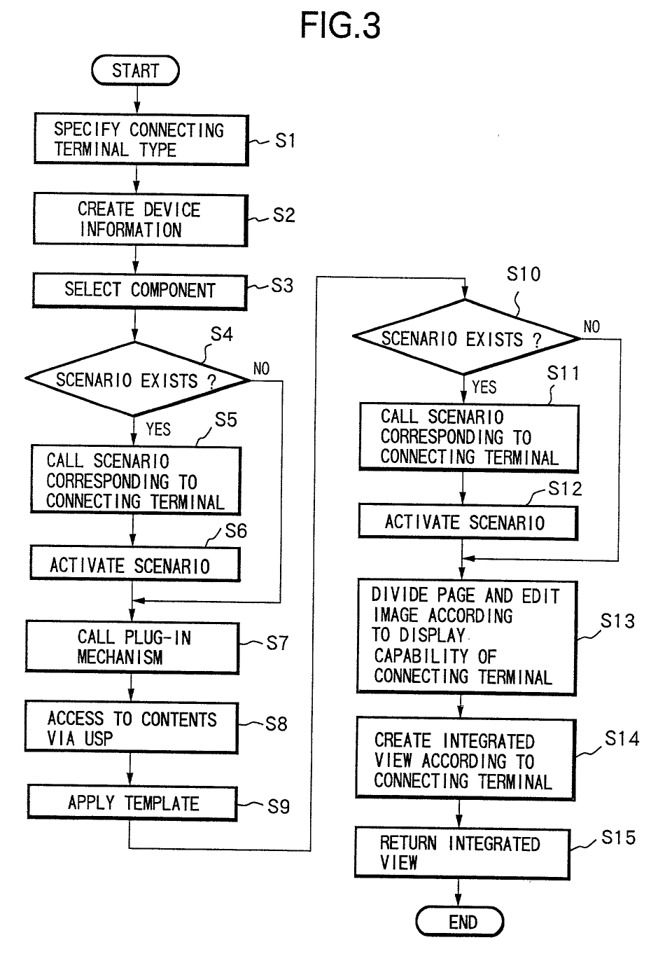

FIG. 3 shows a flowchart of processing details in the portal server 10. Note, such processing is executed, when receiving an http request from the terminal 40.

At step 1 (abbreviated to “S1” in FIG. 3, and the same rule is applied to the following), a header included in the http request is analyzed, to specify the type of the connecting terminal (such as PC 40A, cellular phone 40B, PDA 40C, car navigation system). Note, the procedure of step 1 corresponds to the type specifying function, the type specifying device and the type specifying step.

At step 2, the device information DB 12 is referred to, and after the resolution, number of colors, buffer capacity and the like inherent to the connecting terminal are read out from the device information DB 12, device information representing them in the CC/PP format is created. Note, the procedure of the step 2 corresponds to the display capability judging function, the display capability judging device and the display capability judging step.

At step 3, the advertisement information DB 14 is referred to, and components (scenario and/or USP 24) corresponding to the connecting terminal type are selected. Namely, when the connecting terminal is the cellular phone 40B and the information source 30 is the Web server 30B, a program for cellular phone is selected in the scenario section 30 and the cellular phone connecting USP 24A of the WebUSP is selected, as shown in FIG. 2.

At step 4, the advertisement information DB 14 is again referred to, and it is judged whether or not there exists a program (hereinafter called “scenario”) for processing or editing the contents. Here, the words “there exists a scenario” mean that the scenario section 20 is registered with a program corresponding to the contents or connecting terminal. The flow goes to step 5 if there exists the scenario (Yes), while to step 7 if not (No).

At step 5, the scenario corresponding to the connecting terminal is called.

At step 6, the scenario is activated to perform its own procedure.

At step 7, the plug-in mechanism section 22 is called.

At step 8, the USP 24 corresponding to the connecting terminal is activated, and the contents accumulated in the information source 30 are obtained in the XML format. Note, the procedure of step 8 corresponds the contents obtaining function, the contents obtaining device and the contents obtaining step.

At step 9, the XSLT template corresponding to the connecting terminal type is applied to the obtained XML contents, to be reshaped into XHTML contents corresponding to the display capability of the connecting terminal. Note, the procedure of step 9 corresponds to the contents reshaping function, the contents reshaping device and the contents reshaping step.

At step 10, it is judged whether or not there exists a scenario. The flow goes to step 11 if the scenario exists (Yes), while to step 13 if not (No).

At step 11, the scenario corresponding to the connecting terminal is called.

At step 12, the scenario is activated to perform its own procedure.

At step 13, the page is divided and the image is edited, corresponding to the display capability of the connecting terminal. Namely, based on the device information, the page is divided into displayable sizes, the image is diminished, and background colors, font colors and font sizes are automatically converted into those capable to be processed, respectively. Note, the procedure of step 13 corresponds to the contents dividing function, the contents dividing device and the contents dividing step.

At step 14, an integrated view represented in an xxML format corresponding to the connecting terminal is created, based on the XHTML contents. Note, the procedure at step 14 corresponds to the format converting function, the format converting device and the format converting step.

At step 15, the created integrated view is returned (transmitted) to the connecting terminal. Note, the procedure at step 15 corresponds to the contents transmitting function, the contents transmitting device and the contents transmitting step.

According to the above described portal server 10 as shown in FIG. 14, when the http request from the terminal 40 is received, the connecting terminal type is specified according to the analysis result of the header of the http request. When the connecting terminal type is specified, the device information DB 12 is referred to, the device information indicative of the display capability of the connecting terminal and the like is created. When the device information is created, the advertisement information DB 14 is referred to, the components to be activated are selected. Then, the scenario is activated as required, and its own procedure is executed. At the same time, the XML contents are obtained from the information source 30, through the USP 24 corresponding to the connecting terminal type and information source type.

The XML contents are obtained, the XSLT template DB 16 is referred to, the XML contents are reshaped into the XHTML contents according to the display capability of the connecting terminal. When the XML contents are reshaped into the XHTML contents, the scenario is activated as required, and its own procedure is executed. At the same time, the page division and image edition are performed in conformity with the display capability of the connecting terminal. Then, the integrated view corresponding to the connecting terminal is created based on the XHTML contents, and then the integrated view is transmitted to the connecting terminal.

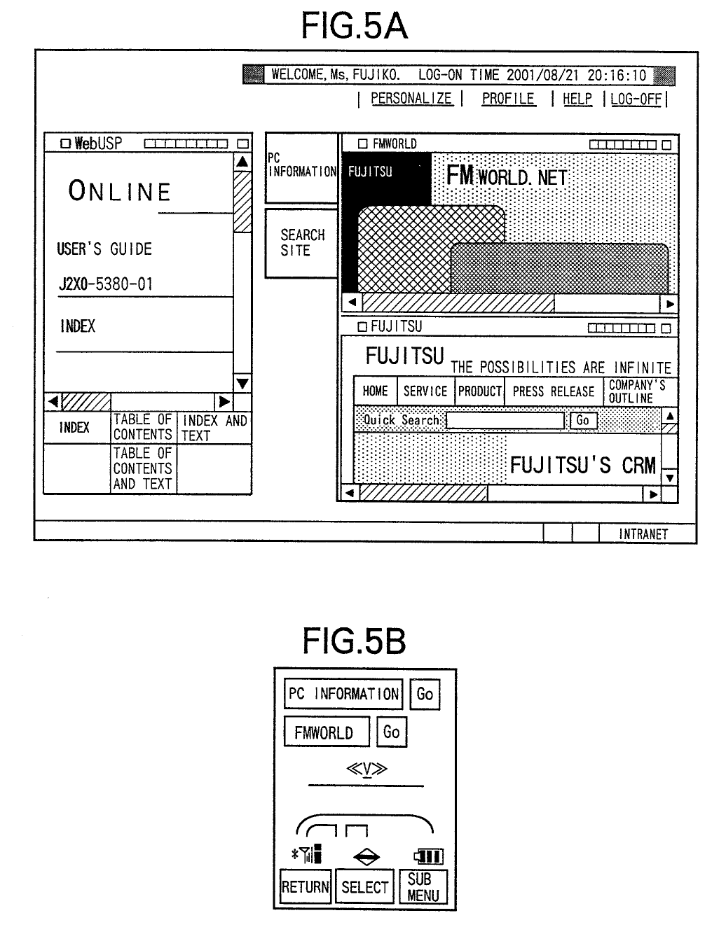

Meanwhile, in the terminal 40, the integrated view processed and edited according to the display capability of the terminal 40 is displayed. Namely, an integrated view as shown in (A) of FIG. 5 is displayed if the terminal 40 is the PC 40A, while if the terminal 40 is the cellular phone 40B, an integrated view simplified corresponding to the resolution and the like of the cellular phone 40B, is displayed as shown in (B) of FIG. 5.

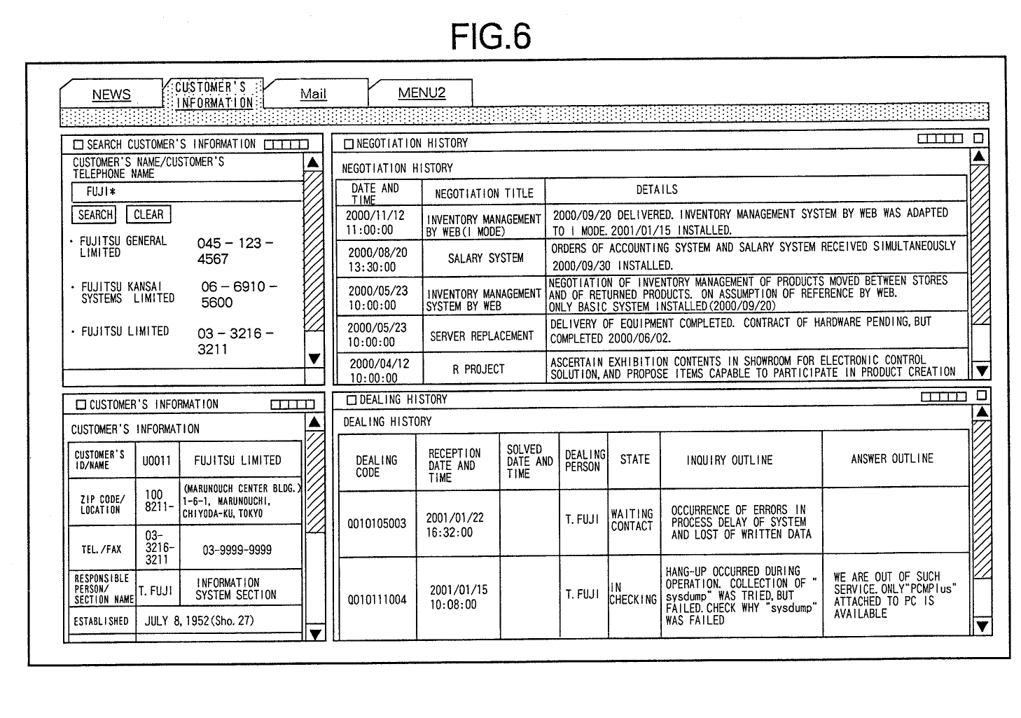

Further, in a case where plural DBs are accessed by a single query, if the terminal 40 is the PC 40A, an integrated view as shown in FIG. 6 is displayed. At this time, inputting a part of customer's name into a customer information search window, a list of customer name candidates is displayed. Then, when a target customer is selected from the list, the selected customer's information, negotiation history and dealing history, are displayed in a customer information window, a negotiation history window and a dealing history window, respectively.

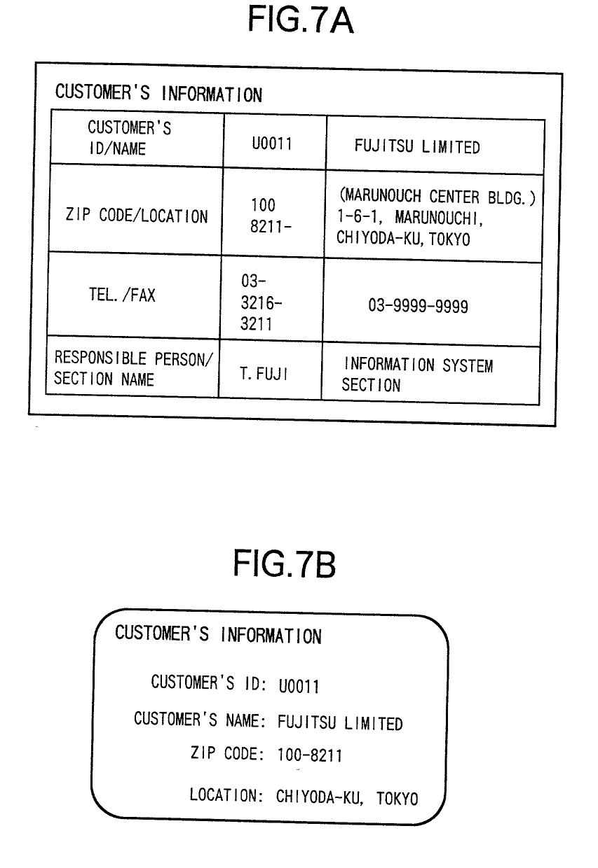

Meanwhile, if the terminal 40 is the PDA 40C, its display area is so small that the windows are displayed one by one as shown in (A) of FIG. 7. At this time, the same page layout within the window as that in the PC is utilized. Moreover, if it is difficult to smoothly use the page layout due to a frequent number of screen scrolls, this page layout is modified by applying the XSLT template.

Further, if the terminal 40 is the cellular phone 40B, its display area is further smaller than the PDA 40C. Thus, a more simplified page layout is displayed as shown in (B) of FIG. 7. At this time, such a function may be added that, when clicking a displayed telephone number, a telephone call to the party specified by the displayed telephone number is transmitted.

In this way, for example, in a case where the same Patent Publication is referred to, the Patent Publication is displayed in conformity with the display capability of the connecting terminal in the following manner. Namely, the entire Patent Publication including drawings can be referred to, in standard, in case of using the PC 40A. Further, in case of using the PDA 40C, the Abstract and Claims of the Patent Publication can be referred to, in standard. In this case, it is possible to refer to the Detailed Description excluding drawings, by designating an option. Meanwhile, in case of using the cellular phone 40B, the Abstract can be referred to, in standard. In this case, it is possible to refer to the Detailed Description excluding the Claims and drawings, by designating an option.

Thus, by using the portal server 10 according to the present invention, it becomes possible to access to the infinitely existing various information sources 30 from various terminals 40. Further, pages are processed and edited according to the display capability of the connecting terminal, for example, thereby enabling to avoid such defects that pages cannot be displayed due to lack of buffer capacity.

Further, for each user of contents, there is an advantage in that the contents can be browsed in the format in conformity with the display capability of the terminal 40 connected to the portal server 10. It is also possible to access to the same contents from arbitrary types of terminals, such as from a PC within a company and from a cellular phone outside the company. Moreover, screen contents are automatically divided corresponding to the buffer capacity of the connecting terminal, thereby enabling to assuredly avoid such defects that the screen cannot be displayed due to lack of buffer capacity.

Furthermore, contents providers can provide the contents to the users of the various terminals 40, in a manner completely free of processing the information sources 30. Thus, it is possible to suppress an increase of costs required for providing the contents and also to provide the contents to more users, thereby enhancing the business chances.

Meanwhile, movements (“Back” and “Forward”) among pages tend to be frequently performed, in the terminals having narrow display areas such as cellular phones. Therefore, It is desirable to provide a mark-&-jump function for enabling to register an arbitrary page so as to jump by one click to this page from another page. In this case, the mark-&-jump function may be embedded into the integrated view when generating it in the converting section 26 (embedding function). Note, the mark-&-jump function is also applicable to PC's having relatively wide display areas.

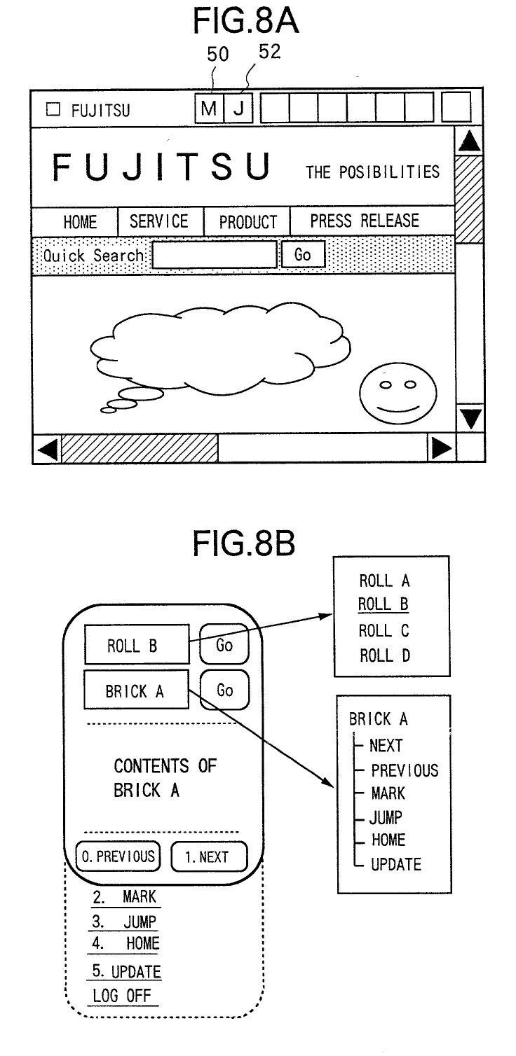

Namely, as shown in (A) of FIG. 8, the page displayed on the monitor of the PC 40A acting as the connecting terminal is added with a Mark button [M] 50 and a Jump button [J] 52 as an identification information storing function and a page moving function, respectively. In attempting to register an arbitrary page, if the Mark button [MJ 50 is pushed, the information for specifying this page is registered in such as a memory. Then, in attempting to move to the registered page while viewing another page, if the Jump button [J] 52 is pushed at an arbitrary point of time, the registered information is read out and the page specified by the information is displayed. Note, in case of the cellular phone 40B, since the display area thereof is restricted, each of the operations of the mark-&-jump is displayed as one item of a pull-down menu as shown in (B) of FIG. 8.

Thus, even in using a terminal having a narrow display area, by using the mark-&-.jump function, the complicated page moving operations can be simplified, and thus, it becomes possible to improve the operability thereof. Further, in using a PC having a relatively wide display area, it is possible to register an arbitrary page so as to jump to the registered page from another page. Thus, by registering a page as a reference, it becomes possible to improve, for example, efficiency and operability when information searching.

By recording a program for realizing such functions into a computer-readable recording medium such as a magnetic tape, magnetic disk, magnetic drum, IC card, CD-ROM, DVD-ROM and the like, the information distributing program according to the present invention can be distributed into the market. Further, those who have obtained such a recording medium can easily construct the information distributing apparatus according to the present invention, using a general computer system.

Moreover, by registering the information distributing program according to the present invention on a server connected to the Internet, the information distributing apparatus according to the present invention can be easily constructed by downloading such a program via telecommunication lines.

What is claimed is:

1. An information distributing program for realizing, on a computer: a type specifying function for specifying, when an access request to contents accumulated in information sources is made, a type of connecting terminal based on said access request; a contents obtaining function for obtaining, based on the connecting terminal type specified by said type specifying function and a data format of said contents, contents in a predetermined format from said information sources; a format converting function for dynamically converting the contents in the predetermined format obtained by said contents obtaining function into a format suitable for said connecting terminal type; and a contents transmitting function for transmitting the contents, the format of which has been converted by said format converting function, to said connecting terminal.

2. An information distributing program according to claim 1, further comprising: a display capability judging function for judging a display capability of said connecting terminal based on the type of said connecting terminal specified by said type specifying function; and a contents reshaping function for reshaping the contents in the predetermined format obtained by said contents obtaining function according to the display capability judged by said display capability judging function.

3. An information distributing program according to claim 2, further comprising a contents dividing function for dividing said contents into multiple contents, according to the display capability judged by said display capability judging function.

4. An information distributing program according to claim 2,
wherein said contents reshaping function reshapes the contents in the predetermined format obtained by said contents obtaining function, by referring to templates according to the display capability of said connecting terminal.

5. An information distributing program according to claim 1,
wherein said type specifying function specifies a type of connecting terminal based on a protocol header with respect to said access request.

6. An information distributing program according to claim 1, further comprising: an identification information storing function for storing identification information of a page, and a page moving function for moving, based on identification information stored by said identification information storing function, to the page identified by said identification information.

7. A computer-readable recording medium recorded with an information distributing program for realizing, on a computer: a type specifying function for specifying, when an access request to contents accumulated in information sources is made, a type of connecting terminal based on said access request; a contents obtaining function for obtaining, based on the connecting terminal type specified by said type specifying function and a data format of said contents, contents in a predetermined format from said information sources; a format converting function for dynamically converting the contents in the predetermined format obtained by said contents obtaining function into a format suitable for said connecting terminal type; and a contents transmitting function for transmitting the contents, the format of which has been converted by said format converting function, to said connecting terminal.

8. A computer-readable recording medium recorded with an information distributing program according to claim 7, further comprising: a display capability judging function for judging a display capability of said connecting terminal based on the type of said connecting terminal specified by said type specifying function; and a contents reshaping function for reshaping the contents in the predetermined format obtained by said contents obtaining function according to the display capability judged by said display capability judging function.

9. A computer-readable recording medium recorded with an information distributing program according to claim 8, further comprising a contents dividing function for dividing said contents into multiple contents, according to the display capability judged by said display capability judging function.

10. An information distributing apparatus comprising: a type specifying device! for specifying, when an access request to contents accumulated in information sources is made, a type of connecting terminal based on said access request; a contents obtaining device for obtaining, based on the connecting terminal type specified by said type specifying device and a data format of said contents, contents in a predetermined format from said information sources; a format converting device for dynamically converting the contents in the predetermined format obtained by said contents obtaining device into a format suitable for said connecting terminal type; and a contents transmitting device for transmitting the contents, the format of which has been converted by said format converting device, to said connecting terminal.

11. An information distributing apparatus according to claim 10, further comprising: a display capability judging device for judging a display capability of said connecting terminal based on the type of said connecting terminal specified by said type specifying device; and a contents reshaping device for reshaping the contents in the predetermined format obtained by said contents obtaining device according to the display capability judged by said display capability judging device.

12. An information distributing apparatus according to claim 11, further comprising a contents dividing device for dividing said contents into multiple contents, according to the display capability judged by said display capability judging device.

13. An information distributing method comprising: a type specifying step of specifying, when an access request to contents accumulated in information sources is made, a type of connecting terminal based on said access request:; a contents obtaining step of obtaining, based on the connecting terminal type specified by said type specifying step and a data format of said contents, contents in a predetermined format from said information sources; a format converting step of dynamically converting the contents in the predetermined format obtained by said contents obtaining step into a format suitable for said connecting terminal type; and a contents transmitting step of transmitting the contents, the format of which has been converted by said format converting step, to said connecting terminal.

14. An information distributing method according to claim 13, further comprising: a display capability judging step of judging a display capability of said connecting terminal based on the type of said connecting terminal specified by said type specifying step; and a contents reshaping step of reshaping the contents in the predetermined format obtained by said contents obtaining step according to the display capability judged by said display capability judging step.

15. An information distributing method according to claim 14, further comprising a contents dividing step of dividing said contents into multiple contents, according to the display capability judged by said display capability judging step.
